(19) United States
(12) Patent Application Publication
(10) Pub. No.: US 2025/0267524 A1
(43) Pub. Date: Aug. 21, 2025

(54) ULTRA HIGH RELIABILITY ROAMING WITH CONTEXT TRANSFER AND REDUCED TRANSITION DELAY

(71) Applicants: Po-Kai HUANG, San Ramon, CA (US); Daniel BRAVO, Portland, OR (US); Danny ALEXANDER, Neve Efraim Monoson (IL); Danny BEN-ARI, Hasharon Hatichon (IL); Ido OUZIELI, Tel Aviv (IL); Johannes BERG, Detmold (DE); Laurent CARIOU, Milizac (FR)

(72) Inventors: Po-Kai HUANG, San Ramon, CA (US); Daniel BRAVO, Portland, OR (US); Danny ALEXANDER, Neve Efraim Monoson (IL); Danny BEN-ARI, Hasharon Hatichon (IL); Ido OUZIELI, Tel Aviv (IL); Johannes BERG, Detmold (DE); Laurent CARIOU, Milizac (FR)

(21) Appl. No.: 19/200,297

(22) Filed: May 6, 2025

Related U.S. Application Data
(60) Provisional application No. 63/643,554, filed on May 7, 2024.
(60) Provisional application No. 63/717,060, filed on Nov. 6, 2024.

(51) Int. Cl. H04W 36/00; H04W 12/03; H04W 28/02

(52) U.S. Cl. CPC H04W 36/0033; H04W 12/03; H04W 28/0268

(57) ABSTRACT

This disclosure describes systems, methods, and devices related to enhanced network integration. A device may transmit, to a current AP MLD, a request frame including a media access control (MAC) address of a target AP MLD. The device may initiate context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple}, wherein each variable in the UP{tuple} represents a user priority associated with a value tuple of a masked classifier parameters, corresponding to the active MSCS from the current AP MLD to the target AP MLD.

### CROSS-REFERENCE TO RELATED APPLICATION(S)

This application claims the benefit of U.S. Provisional Application No. 63/643,554, filed May 7, 2024, and U.S. Provisional Application No. 63/717,060, filed Nov. 6, 2024, all disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced network integration, in accordance with one or more example embodiments of the present disclosure.

FIGS. 2-3 depict illustrative schematic diagrams for data continuity, in accordance with one or more example embodiments of the present disclosure.

FIGS. 4-6 depict illustrative schematic diagrams for enhanced network integration, in accordance with one or more example embodiments of the present disclosure.

FIG. 7 illustrates a flow diagram of a process for an illustrative enhanced network integration system, in accordance with one or more example embodiments of the present disclosure.

FIG. 8 illustrates a functional diagram of an exemplary communication station that may be suitable for use as a user device, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

FIG. 10 is a block diagram of a radio architecture in accordance with some examples.

FIG. 11 illustrates an example front-end module circuitry for use in the radio architecture of FIG. 10, in accordance with one or more example embodiments of the present disclosure.

FIG. 12 illustrates an example radio IC circuitry for use in the radio architecture of FIG. 10, in accordance with one or more example embodiments of the present disclosure.

FIG. 13 illustrates an example baseband processing circuitry for use in the radio architecture of FIG. 10, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (Institute of Electrical and Electronics Engineers (IEEE) 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

In IEEE 802.11be (“11be”), a wireless networking standard also known as Wi-Fi 7, which supports Extremely High Throughput (EHT) and multi-link operation, a multi-link device (MLD) is defined to allow multiple links to be established between an access point multi-link device (AP MLD) and non-access point multi-link device (non-AP MLD). An AP MLD consists of multiple affiliated access points (APs) capable of coordinated transmission and reception across different frequency bands, while a non-AP MLD consists of affiliated non-AP stations (STAs).

Consider a typical transition scenario from current AP MLD to target AP MLD. The major problem of existing roaming is that after the transition.

Uplink (UL) and downlink (DL) data are flushed and have to rely on upper layer retransmission to continue transmission after transition. Uplink refers to data sent from the client device to the AP, while downlink refers to data sent from the AP to the client. Upper layers refer to layers in the OSI model above the data link layer, such as the transport layer (e.g., TCP). It should be understood that in this context, flushing data refers to the discarding of in-progress UL and DL transmissions during the transition of an MLD from one AP MLD to another. This occurs because the network session is disrupted, often due to changes in IP address, DHCP configurations, or loss of session security contexts. As a result, any data packets that were being transmitted are lost and may not be able to be resumed seamlessly. Instead, the system must rely on upper-layer protocols, such as TCP, to detect the loss and retransmit the data. This increases latency and negatively impacts user experience, particularly in applications that require continuous or real-time data exchange.

If the current AP MLD and target AP MLD is under situations like different Dynamic Host Configuration Protocol (DHCP) servers or different Internet Protocol (IP) address subnets, then a new IP address is required after transition, and Transmission Control Protocol (TCP) connection then needs to be re-setup before data communication can continue. DHCP is used to assign IP addresses to devices on a network automatically, while TCP ensures reliable data transmission between devices.

Flushing data and assignment of new IP address significantly increases the time to resume data communication after transition.

A previous solution tried to avoid UL and DL data flush by ensuring that contexts like Pairwise Master Key Security Association (PMKSA), Pairwise Transient Key Security Association (PTKSA), and sequence number (SN) assignment can be transferred to target AP MLD, and as a result, UL and DL data can continue and complete flush is not required. PMKSA and PTKSA are cryptographic credentials used in secure Wi-Fi authentication processes (e.g., WPA3), and SN helps maintain proper data packet order during transmission.

Roaming has been an important topic in 11bn. Consider non-AP MLD to roam from current AP MLD to target AP MLD. The procedure is for non-AP MLD to have frame exchange to initiate roaming. The current proposal is to have roaming frame exchange, which will be called roaming request/response in this disclosure, with current AP MLD, and current AP MLD will coordinate with target AP MLD to transfer contexts and continue roaming procedure with target AP MLD. This procedure has the benefits that the roaming request/response can be protected because the current secure connection with current AP MLD is leveraged. This option is also useful in the sense that most of the cases when roaming is initiated existing connection is still there.

However, the option to have roaming request/response exchange with target AP MLD is also needed. There are legit use cases when roaming is initiated, the current connection with current AP MLD is not there anymore. The problem with this option is that the roaming request/response is then not protected if transmit directly target AP MLD to transfer context from current AP MLD.

There is a solution from Broadcom to distribute a key for each non-AP MLD to every AP MLD in the ESS. Non-AP MLD can then encrypt roaming request/response with this key directly.

The solution requires AP MLD to try one by one which key is going to work because the encrypted roaming request does not have indication on which key it referred to. Also, since there is no PN sync, a nonceless encryption is used, but this also creates problems for replay of encrypted roaming request.

Except contexts like pairwise master key security association (PMKSA), pairwise transient key (PTK) security association (PTKSA), or sequence number (SN) assignment, there are other contexts that also needs to be transferred to ensure that it is not necessary to perform data flush for specific traffic identifier (TID).

Accepted stream classification service (SCS) descriptor on current AP MLD.

Accepted mirrored stream classification service (MSCS) descriptor on current AP MLD.

For MSCS, current AP MLD learned logical list of UP{tuple}, where each variable represents a user priority associated with a value tuple of the masked classifier parameters.

An indication that New IP address is not required is proposed to inform that non-AP MLD does not need to waste time on checking whether existing IP address can be reused.

After non-AP MLD receives the bit, the non-AP MLD can notify upper layer not to recheck IP address after roaming and can directly continue with data transmission after roaming.

SCS descriptor helps to map DL data to specific TID. If different mapping is used on target AP MLD, then it creates problems on how to maintain data continuity on non-AP MLD after transmission. For example, a traffic stream may be mapped to TID 1 in current AP MLD, but it is mapped to TID 2 in target AP MLD or unmapped, then client has a problem to maintain delivery for the traffic stream accepted SCS descriptor on current AP MLD.

MSCS descriptor and learning results are useful for AP MLD to map DL packet for MSCS. It will help that target AP MLD does not have to relearn and classify data with wrong UP in the meantime.

Expect that most of the deployment uses one dynamic host configuration protocol (DHCP) server and puts AP MLD in the same roaming domain with the same IP address assignment subnet. However, today non-AP MLD does not know and have to recheck whether existing IP addresses can be used after roaming with DHCP discovery information exchange.

Example embodiments of the present disclosure relate to systems, methods, and devices for ultra high reliability (UHR) Roaming request and response exchange for context transfer.

The central concept is to have one additional frame exchange to have key available to encrypt roaming frame exchange with target AP MLD.

The additional frame exchange will have the key ready on Target AP MLD to receive encrypted frame that initiates UHR roaming.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

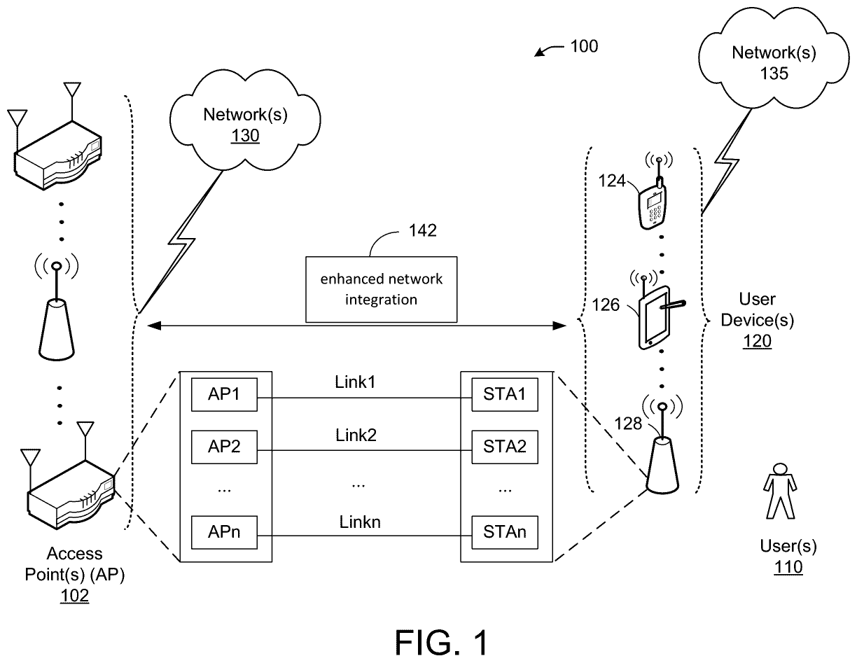

FIG. 1 is a network diagram illustrating an example network environment of enhanced network integration, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

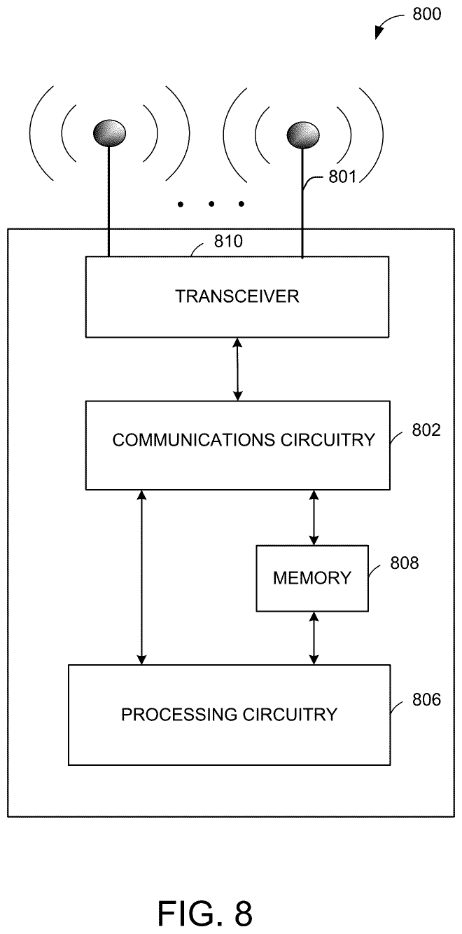

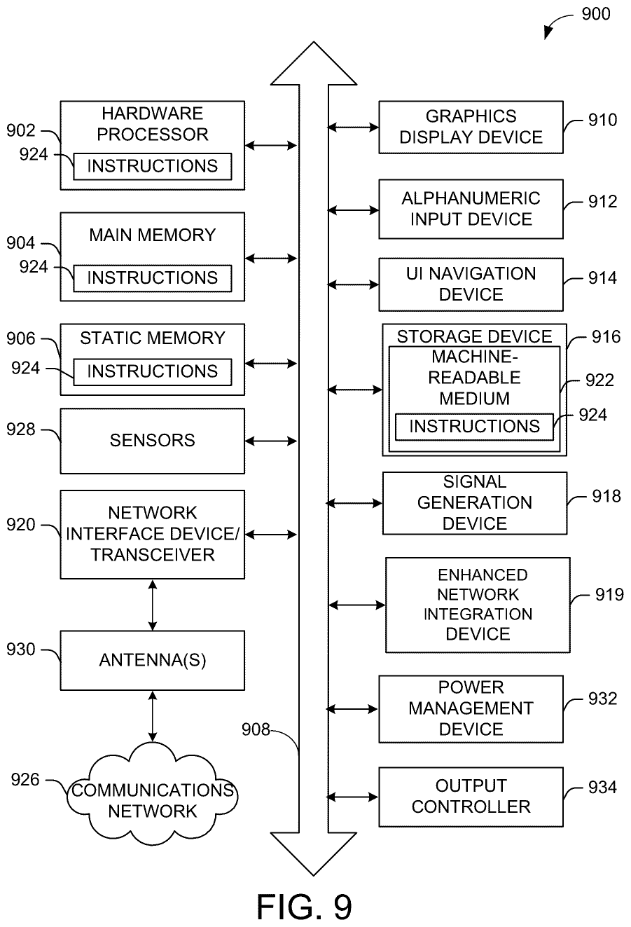

In some embodiments, the user devices 120 and the AP 102 may include one or more computer systems similar to that of the functional diagram of FIG. 8 and/or the example machine/system of FIG. 9.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IOT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHZ channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced network integration 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

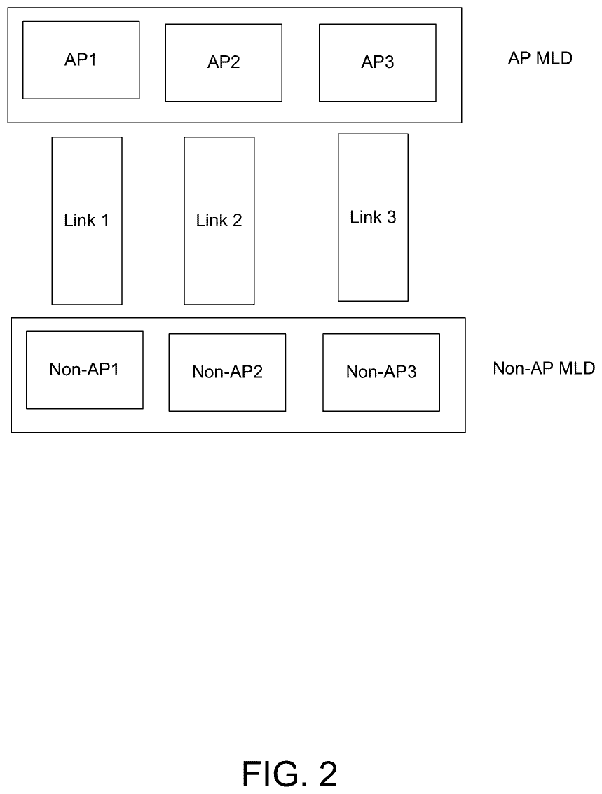

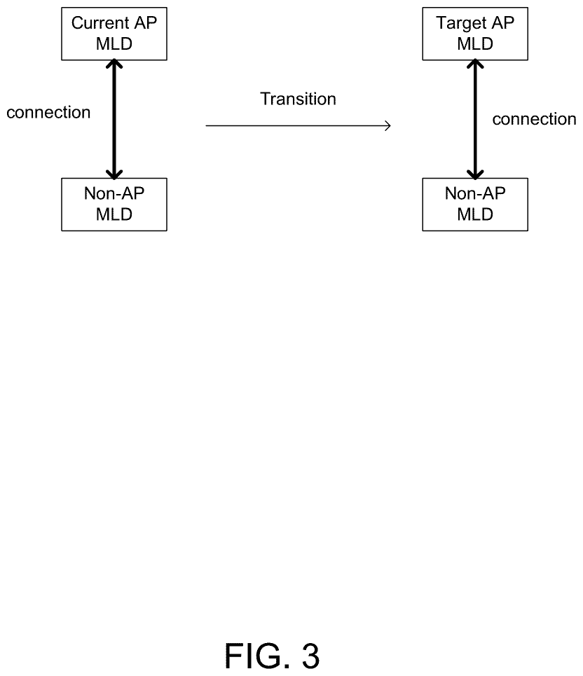

FIGS. 2-3 depict illustrative schematic diagrams for data continuity, in accordance with one or more example embodiments of the present disclosure.

In IEEE 802.11be (“11be”), multi-link device (MLD) is defined to allow multiple links to be established between an AP MLD and non-AP MLD. AP MLD has affiliated APs, and non-AP MLD has affiliated non-AP STAs as shown in FIG. 2.

The idea is that multiple links can be set up so that non-AP MLD can use any links afterwards.

Note that when non-AP MLD uses different links, there is no need to do any further sequence exchange beyond existing power save mechanism allowed in each link. As a result, MLD functionality simplifies the message exchange required to switch link to a minimum.

Consider a typical transition scenario in FIG. 3 from current AP MLD to target AP MLD.

The major problem of existing roaming is that after the transition.

UL and DL data are flushed and have to rely on upper layer retransmission to continue transmission after transition

If the current AP MLD and target AP MLD is under situations like different DHCP servers or different IP address subnet, then a new IP address is required after transition, and TCP connection then needs to be re-setup before data communication can continue.

Flushing data and assignment of new IP address significantly increases the time to resume data communication after transition.

A previous solution tries to avoid UL and DL data flush by ensuring that contexts like PMKSA, PTKSA, SN assignment can be transferred to target AP MLD and as a result, UL and DL data can continue and completely flush is not required.

Referring to FIG. 3, consider the scenario of a non-AP MLD to transition from a current AP MLD to a target AP MLD.

In one or more embodiments, a data continuity system may facilitate that the following contexts can be transferred to target AP MLD from the current AP MLD to ensure that it is not necessary to perform data flush for specific TID.

Accepted stream classification service (SCS) descriptor in SCS descriptor element on current AP MLD.

Accepted MSCS descriptor in MSCS descriptor element on current AP MLD.

For mirrored stream classification service (MSCS), current AP MLD learned logical list of UP{tuple}, where each variable represents a user priority associated with a value tuple of the masked classifier parameters.

The authorization information included in the dot11InterworkingEntry for the non-AP

MLD to use the EPCS priority access.

Transfer of the contexts can be:

Initiated by non-AP MLD in a request/response exchange with current AP MLD or target AP MLD.

The request frame will indicate current AP MLD and/or target AP MLD to know the source and destination of the context transfer.

After the request frame and response frame exchange, a distribution system (DS) mapping change from current AP MLD to target AP MLD may be notified. This notification informs the DS how the backhaul should forward the data, using a DS_NOTIFY interface to communicate the updated mapping to the higher layer.

Without notifying DS mapping change implies that context transfer is done beforehand to shorten the transition later during actual transition.

Notifying DS mapping change implies that context transfer is done together with the transition if doing steps beforehand is not possible.

A signaling in the response frame indicates that New IP address is not required after transition or Existing IP address can be reused.

If the signaling does not indicate New IP address is not required after transition or Existing IP address can be reused, then it means that it is unknown whether new IP address is required or not after transition.

If the signaling does not indicate New IP address is not required after transition or Existing IP address can be reused, then the mapping of a Hardware Address to Internet Address mapping for each IPv4 and IPV6 address of the non-AP MLD is also transferred to the target AP MLD to maintain the proxy ARP service.

How AP MLD figures out how to set the signaling is out of the scope of the standard.

An AP MLD may know if say all AP MLD in the same ESS are setup to be assigned IP address under one DHCP and all AP MLD are in the same subnet for IP address assignment.

Current AP MLD and target AP MLD may compare DHCP discovery result to understand if they are under the same DHCP assignment pools.

To ensure that context transfer can be done, it is further proposed requirements below when 11bn roaming mechanism is used for transition from current AP MLD to target AP MLD,

All APs affiliated with the current AP MLD or target AP MLD shall set SCS (a bit) in Extended capabilities field in Extended Capabilities element to the same value.

All APs affiliated with the current AP MLD or target AP MLD shall set Mirrored SCS in Extended capabilities field in Extended Capabilities element to the same value.

All APs affiliated with the current AP MLD or target AP MLD shall set QoS Map in Extended capabilities field in Extended Capabilities element to the same value.

All APs affiliated with the current AP MLD or target AP MLD shall set Proxy ARP in Extended capabilities field in Extended Capabilities element to the same value.

All APs affiliated with the current AP MLD or target AP MLD shall set EPCS Priority Access Support subfield of the EHT Capabilities element to the same value.

All APs affiliated with the current AP MLD or target AP MLD shall has the same QoS Mapping information to be delivered to the non-AP MLD.

The request and response frame for context transfer can also be used for embedding negotiation to setup other new contexts with target AP MLD:

Existing methods to embed negotiations in (re)association request/response frame with specific elements can be reused here, where specific elements included in the request/response frame to indicate specific negotiation procedures.

Indication of unavailability for non-AP MLD on the new channels and bands of the target AP MLD can be indicated in the request frame.

The response frame for context transfer can also be used for indicating required new information for existing operation:

EDCA parameter set(s) and/or MU EDCA parameter set(s) that the destination EPCS non-AP MLD employs on the corresponding setup links of the target AP MLD.

It is understood that the above descriptions are for the purposes of illustration and are not meant to be limiting.

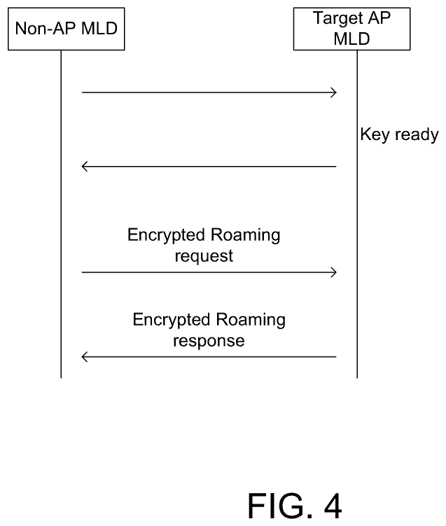

FIGS. 4-6 depict illustrative schematic diagrams for enhanced network integration, in accordance with one or more example embodiments of the present disclosure.

In one or more embodiments, an enhanced network integration system may facilitate having one additional frame exchange to have key available to encrypt roaming frame exchange with target AP MLD.

The additional frame exchange will have the key ready on Target AP MLD to receive encrypted frame that initiates UHR roaming, as shown in FIG. 4.

In one or more embodiments, a enhanced network integration system may facilitate a non-AP MLD to roam from current AP MLD to target AP MLD with the UHR roaming mechanism with context transfer.

In one or more embodiments, it is proposed to allow frame exchange with Target AP MLD directly to initiate UHR roaming with context transfer. The frame exchange for roaming and context transfer can use any frame to achieve the purpose. The generic term roaming request/response is used in this disclosure.

In one or more embodiments, it proposed to have one additional frame exchange with target AP MLD before the roaming request/response frame with the target AP MLD to have a key available on the Target AP MLD.

In a secure wireless communication setup, the key derivation process involves an exchange of specific cryptographic values between a client device (non-AP MLD) and an access point (AP MLD). During the initial handshake, the request or response frame includes the Supplicant Nonce (SNonce) and a Diffie-Hellman (DH) parameter. The SNonce is a randomly generated value used once to ensure freshness and protect against replay attacks, while the DH parameter represents the client's public key component in the DH key exchange protocol. In a subsequent response frame, the access point sends its own Authenticator Nonce (ANonce) along with its corresponding DH parameter. With both the SNonce and ANonce, and each party's DH public parameter, the client and the access point independently compute the same shared secret using their respective private keys and the peer's public DH value. This shared secret is then combined with the nonces and other identifying information (such as MAC addresses) in a key derivation function to produce a new Pairwise Transient Key (PTK), which is used to secure unicast data communications between the devices.

Target AP MLD has the key ready before sending the response frame.

Non-AP MLD has the key ready before sending the encrypted roaming request frame with the key.

Frame 2 can include MIC based on the key for non-AP MLD to verify.

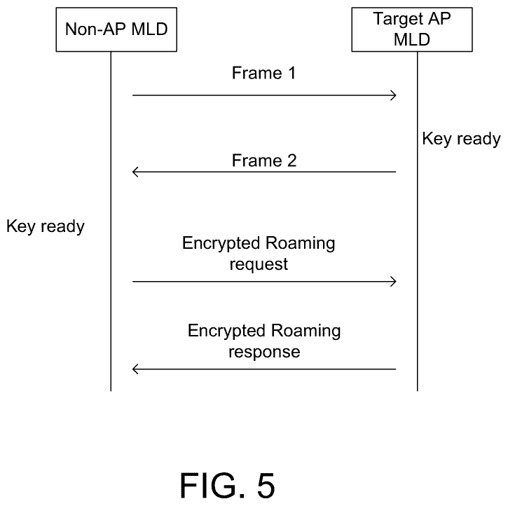

It is proposed that roaming request will have indication of current AP MLD and target AP MLD to simplify the various modes of exchange that will be introduced in FIG. 5.

Two options are proposed to have the key on target AP MLD.

All AP MLDs in the same ESS can advertise the same option to the non-AP MLD to support.

Option 1: reuse existing PTK (with the current AP MLD) with the target AP MLD.

Frame 1 will include address of current AP MLD for target AP MLD to contact and retrieve the PTK.

Frame 1 can include PMKID for target AP MLD to convey to current AP MLD to identify the PMKSA corresponding to the PMKID and the non-AP MLD. Then use the address of the non-AP MLD to identify the corresponding PTKSA and the corresponding PTK and TK. PMKID will be recomputed after the successful exchange of roaming request/response to avoid the privacy issue.

Frame 1 can include additional PTKID to help the Target AP MLD to contact current AP MLD and identify PTK directly:

PTKID can be derived once PTK is derived.

PTKID will be recomputed after the successful exchange of roaming request/response to avoid privacy issues.

Once the PTK is identified, the current AP MLD transfers the PTK and the current reply counter for TK and management frame to target AP MLD.

Target AP MLD sends the frame 2 in response to frame 1. Using KCK for the MIC if necessary.

Non-AP MLD already holds the PTK and can then encrypt roaming request with TK and send roaming request to Target AP MLD.

Option 2: Derive new PTK with the target AP MLD:

Frame 1 will include PMKID for target AP MLD to identify PMK.

Frame 1 will include address of current AP MLD for target AP MLD to contact and retrieve the PMK if needed.

Frame 1 can include ANonce and/or Diffie-Hellman (DH) parameter to help derive PTK.

The TK and PTK are then derived from the PMK.

The TK and PTK can be under the same PTKSA in this case, and Frame 1 will include the current key ID.

The TK and PTK can be a new PTKSA, and the new key will start with key ID 0.

When non-AP MLD sends data to Target AP MLD, non-AP MLD can continue with the PN already assigned to the data frame with previous TK rather than starting with PN 0.

Target AP MLD sends frame 2 once PTKSA derivation is finished. Use KCK for the MIC if necessary.

Frame 2 can include SNonce and/or DH parameter to help derive PTK.

Non-AP MLD can hold additional reply counter for the target AP MLD on management frame since a new TK is used.

Non-AP MLD maintains a received reordering buffer to receive data from both current AP MLD and target AP MLD with different TK during transient period:

If it is different TK with different Key ID, non-AP MLD maintains key ID for each received data in the received reordering buffer and when doing replay, maintains replay counter for different key ID and doing replay for different key ID separately.

If it is different TK with the same key ID 0, non-AP MLD maintains AP MLD MAC address for each received data in the received reordering buffer and when doing replay, maintains replay counter for different AP MLD MAC address and doing replay for different AP MLD MAC address separately.

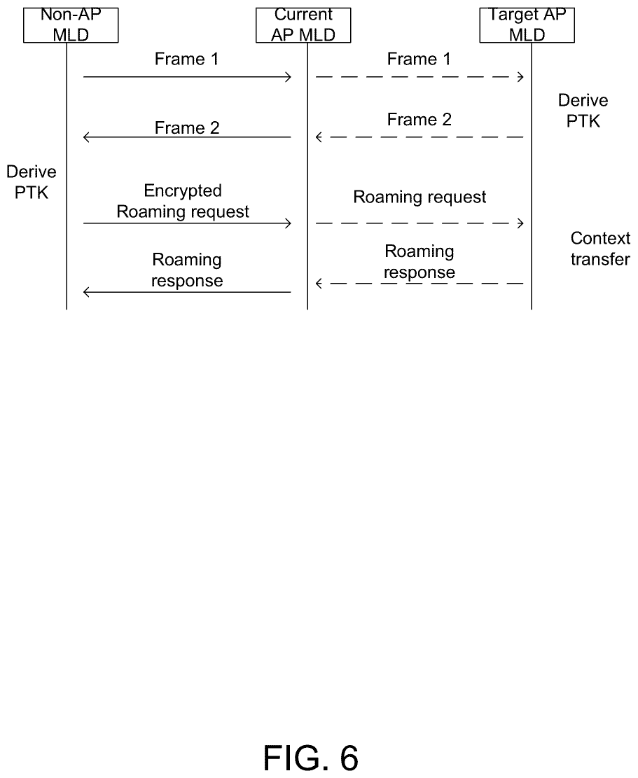

With option 2: it is possible to have a similar procedure to derive new key when the roaming request/response is exchanged with current AP MLD, as shown in FIG. 6.

Frame 1 will include PMKID and ANonce to help derive new PTK:

PMK and ANonce are tunneled to target AP MLD to derive new PTK

Frame 1 can include DH parameter to help derive new PTK.

Frame 2 will include SNonce and MIC of frame 2 based on KCK of new PTK from Target AP MLD to help derive and verify new PTK.

Frame 2 can include DH parameter to help derive new PTK.

Frame 1 and Frame 2 are encrypted with TK with current AP MLD for exchange with current AP MLD.

Roaming request and roaming response are encrypted with TK with current AP MLD for exchange with current AP MLD:

Roaming request contains MIC of the roaming request frame based on KCK of new PTK for target AP MLD to verify.

Roaming response contains MIC of the roaming response frame based on KCK of new PTK from target AP MLD for non-AP MLD to verify.

It is understood that the above descriptions are for the purposes of illustration and are not meant to be limiting.

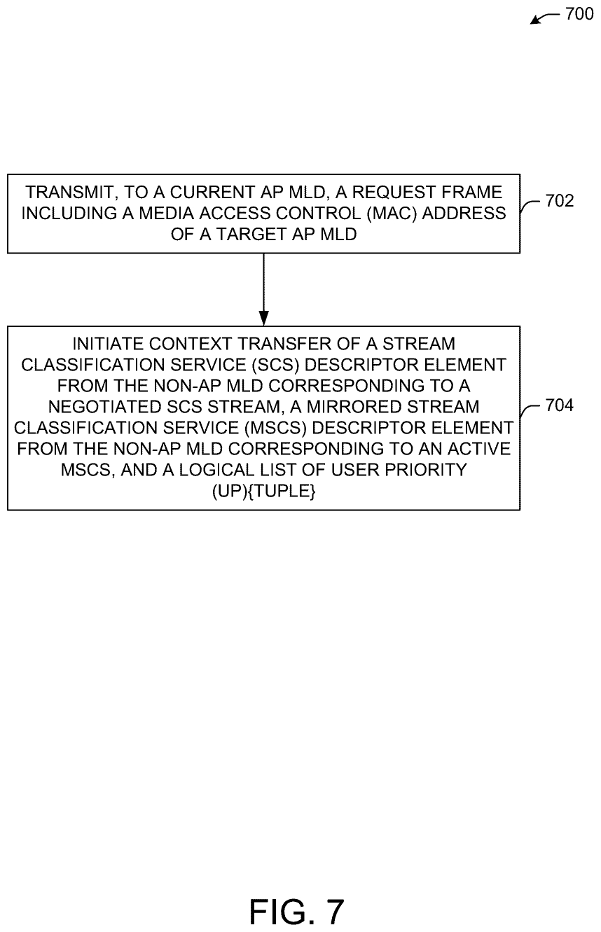

FIG. 7 illustrates a flow diagram of illustrative process 700 for an enhanced network integration system, in accordance with one or more example embodiments of the present disclosure.

At block 702, a device (e.g., the user device(s) 120 and/or the AP 102 of FIG. 1 and/or the enhanced network integration device 919 of FIG. 9) may transmit, to a current AP MLD, a request frame including a media access control (MAC) address of a target AP MLD.

At block 704, the device may initiate context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple}, wherein each variable in the UP{tuple} represents a user priority associated with a value tuple of a masked classifier parameters, corresponding to the active MSCS from the current AP MLD to the target AP MLD. Each tuple represents a structured set of classifier parameters—such as source and destination IP addresses, port numbers, and protocol type—associated with a user priority (UP). These tuples enable the target AP MLD to accurately interpret and maintain the classification and prioritization behavior for ongoing data streams without requiring reclassification or disruption

It is understood that the above descriptions are for the purposes of illustration and are not meant to be limiting.

FIG. 8 shows a functional diagram of an exemplary communication station 800, in accordance with one or more example embodiments of the present disclosure. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), an enhanced network integration device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 902 for generation and processing of the baseband signals and for controlling operations of the main memory 904, the storage device 916, and/or the enhanced network integration device 919. The baseband processor may be provided on a single radio card, a single chip, or an integrated circuit (IC).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The enhanced network integration device 919 may carry out or perform any of the operations and processes (e.g., process 700) described and shown above.

It is understood that the above are only a subset of what the enhanced network integration device 919 may be configured to perform and that other functions included throughout this disclosure may also be performed by the enhanced network integration device 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

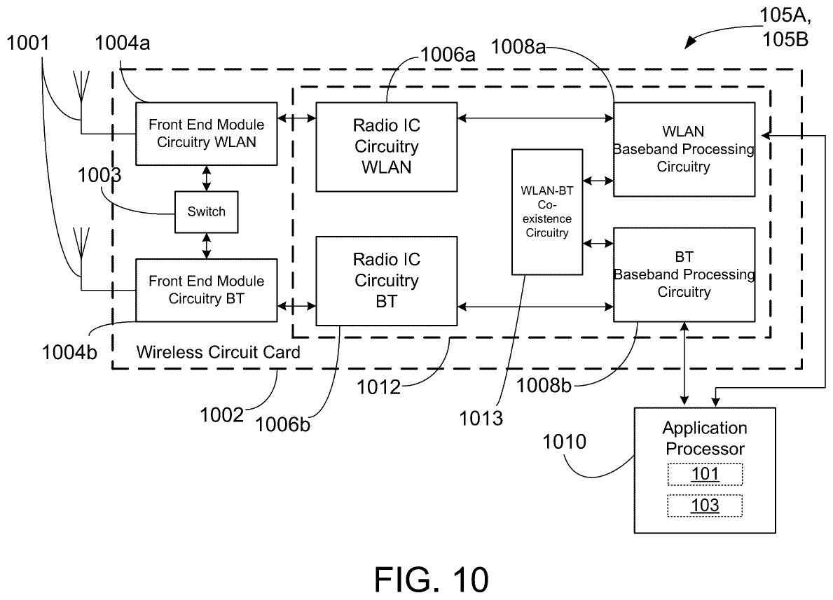

FIG. 10 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1004a-b, radio IC circuitry 1006a-b and baseband processing circuitry 1008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1004a-b may include a WLAN or Wi-Fi FEM circuitry 1004a and a Bluetooth (BT) FEM circuitry 1004b. The WLAN FEM circuitry 1004a may include a receive signal path comprising circuitry configured to operate on WLAN RF signals received from one or more antennas 1001, to amplify the received signals and to provide the amplified versions of the received signals to the WLAN radio IC circuitry 1006a for further processing. The BT FEM circuitry 1004b may include a receive signal path which may include circuitry configured to operate on BT RF signals received from one or more antennas 1001, to amplify the received signals and to provide the amplified versions of the received signals to the BT radio IC circuitry 1006b for further processing. FEM circuitry 1004a may also include a transmit signal path which may include circuitry configured to amplify WLAN signals provided by the radio IC circuitry 1006a for wireless transmission by one or more of the antennas 1001. In addition, FEM circuitry 1004b may also include a transmit signal path which may include circuitry configured to amplify BT signals provided by the radio IC circuitry 1006b for wireless transmission by the one or more antennas. In the embodiment of FIG. 10, although FEM 1004a and FEM 1004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1006a-b as shown may include WLAN radio IC circuitry 1006a and BT radio IC circuitry 1006b. The WLAN radio IC circuitry 1006a may include a receive signal path which may include circuitry to down-convert WLAN RF signals received from the FEM circuitry 1004a and provide baseband signals to WLAN baseband processing circuitry 1008a. BT radio IC circuitry 1006b may in turn include a receive signal path which may include circuitry to down-convert BT RF signals received from the FEM circuitry 1004b and provide baseband signals to BT baseband processing circuitry 1008b. WLAN radio IC circuitry 1006a may also include a transmit signal path which may include circuitry to up-convert WLAN baseband signals provided by the WLAN baseband processing circuitry 1008a and provide WLAN RF output signals to the FEM circuitry 1004a for subsequent wireless transmission by the one or more antennas 1001. BT radio IC circuitry 1006b may also include a transmit signal path which may include circuitry to up-convert BT baseband signals provided by the BT baseband processing circuitry 1008b and provide BT RF output signals to the FEM circuitry 1004b for subsequent wireless transmission by the one or more antennas 1001. In the embodiment of FIG. 10, although radio IC circuitries 1006a and 1006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1008a-b may include a WLAN baseband processing circuitry 1008a and a BT baseband processing circuitry 1008b. The WLAN baseband processing circuitry 1008a may include a memory, such as, for example, a set of RAM arrays in a Fast Fourier Transform or Inverse Fast Fourier Transform block (not shown) of the WLAN baseband processing circuitry 1008a. Each of the WLAN baseband circuitry 1008a and the BT baseband circuitry 1008b may further include one or more processors and control logic to process the signals received from the corresponding WLAN or BT receive signal path of the radio IC circuitry 1006a-b, and to also generate corresponding WLAN or BT baseband signals for the transmit signal path of the radio IC circuitry 1006a-b. Each of the baseband processing circuitries 1008a and 1008b may further include physical layer (PHY) and medium access control layer (MAC) circuitry, and may further interface with a device for generation and processing of the baseband signals and for controlling operations of the radio IC circuitry 1006a-b.

Referring still to FIG. 10, according to the shown embodiment, WLAN-BT coexistence circuitry 1013 may include logic providing an interface between the WLAN baseband circuitry 1008a and the BT baseband circuitry 1008b to enable use cases requiring WLAN and BT coexistence. In addition, a switch 1003 may be provided between the WLAN FEM circuitry 1004a and the BT FEM circuitry 1004b to allow switching between the WLAN and BT radios according to application needs. In addition, although the antennas 1001 are depicted as being respectively connected to the WLAN FEM circuitry 1004a and the BT FEM circuitry 1004b, embodiments include within their scope the sharing of one or more antennas as between the WLAN and BT FEMs, or the provision of more than one antenna connected to each of FEM 1004a or 1004b.

In some embodiments, the front-end module circuitry 1004a-b, the radio IC circuitry 1006a-b, and baseband processing circuitry 1008a-b may be provided on a single radio card, such as wireless radio card 1002. In some other embodiments, the one or more antennas 1001, the FEM circuitry 1004a-b and the radio IC circuitry 1006a-b may be provided on a single radio card. In some other embodiments, the radio IC circuitry 1006a-b and the baseband processing circuitry 1008a-b may be provided on a single chip or integrated circuit (IC), such as IC 1012.

In some embodiments, the wireless radio card 1002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHz, 5 GHZ, and bandwidths of about 2 MHz, 4 MHz, 5 MHz, 5.5 MHz, 6 MHz, 8 MHz, 10 MHz, 20 MHz, 40 MHz, 80 MHZ (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

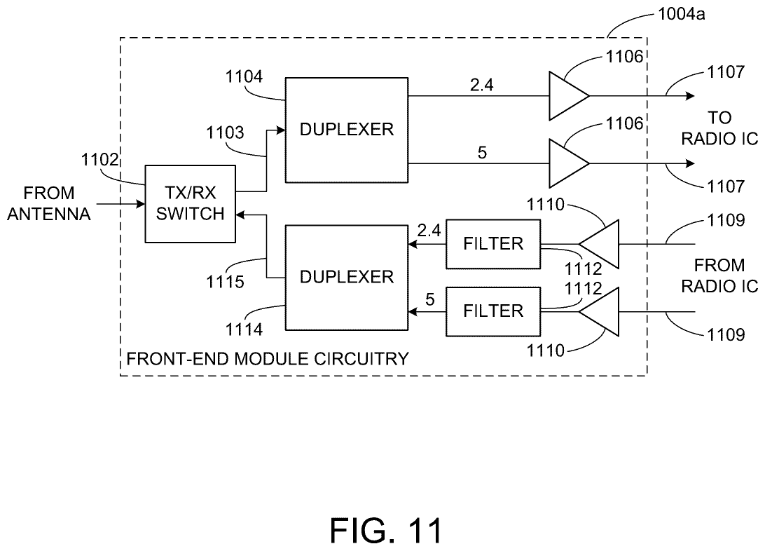

FIG. 11 illustrates WLAN FEM circuitry 1004a in accordance with some embodiments. Although the example of FIG. 11 is described in conjunction with the WLAN FEM circuitry 1004a, the example of FIG. 11 may be described in conjunction with the example BT FEM circuitry 1004b (FIG. 10), although other circuitry configurations may also be suitable.

In some embodiments, the FEM circuitry 1004a may include a TX/RX switch 1102 to switch between transmit mode and receive mode operation. The FEM circuitry 1004a may include a receive signal path and a transmit signal path. The receive signal path of the FEM circuitry 1004a may include a low-noise amplifier (LNA) 1106 to amplify received RF signals 1103 and provide the amplified received RF signals 1107 as an output (e.g., to the radio IC circuitry 1006a-b (FIG. 10)). The transmit signal path of the circuitry 1004a may include a power amplifier (PA) to amplify input RF signals 1109 (e.g., provided by the radio IC circuitry 1006a-b), and one or more filters 1112, such as band-pass filters (BPFs), low-pass filters (LPFs) or other types of filters, to generate RF signals 1115 for subsequent transmission (e.g., by one or more of the antennas 1001 (FIG. 10)) via an example duplexer 1114.

In some dual-mode embodiments for Wi-Fi communication, the FEM circuitry 1004a may be configured to operate in either the 2.4 GHz frequency spectrum or the 5 GHz frequency spectrum. In these embodiments, the receive signal path of the FEM circuitry 1004a may include a receive signal path duplexer 1104 to separate the signals from each spectrum as well as provide a separate LNA 1106 for each spectrum as shown. In these embodiments, the transmit signal path of the FEM circuitry 1004a may also include a power amplifier 1110 and a filter 1112, such as a BPF, an LPF or another type of filter for each frequency spectrum and a transmit signal path duplexer 1104 to provide the signals of one of the different spectrums onto a single transmit path for subsequent transmission by the one or more of the antennas 1001 (FIG. 10). In some embodiments, BT communications may utilize the 2.4 GHz signal paths and may utilize the same FEM circuitry 1004a as the one used for WLAN communications.

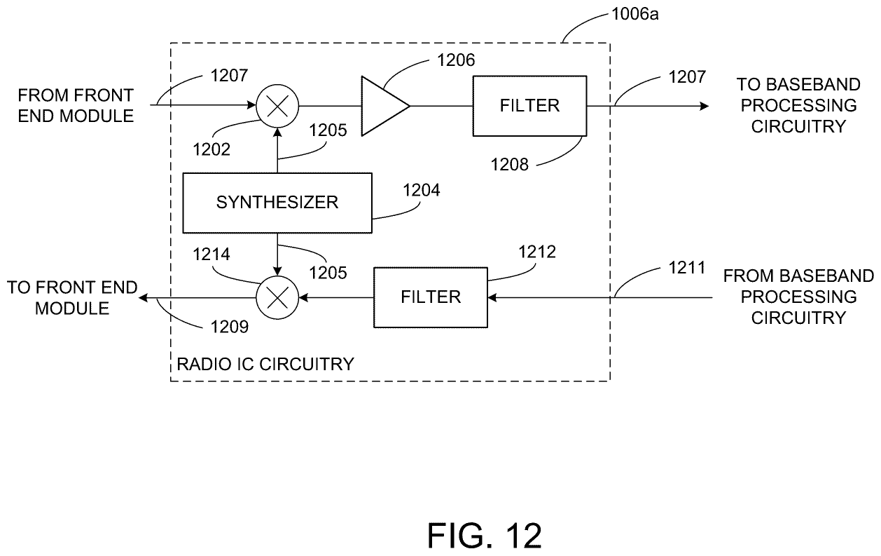

FIG. 12 illustrates radio IC circuitry 1006a in accordance with some embodiments. The radio IC circuitry 1006a is one example of circuitry that may be suitable for use as the WLAN or BT radio IC circuitry 1006a/1006b (FIG. 10), although other circuitry configurations may also be suitable. Alternatively, the example of FIG. 12 may be described in conjunction with the example BT radio IC circuitry 1006b.

In some embodiments, the radio IC circuitry 1006a may include a receive signal path and a transmit signal path. The receive signal path of the radio IC circuitry 1006a may include at least mixer circuitry 1202, such as, for example, down-conversion mixer circuitry, amplifier circuitry 1206 and filter circuitry 1208. The transmit signal path of the radio IC circuitry 1006a may include at least filter circuitry 1212 and mixer circuitry 1214, such as, for example, up-conversion mixer circuitry. Radio IC circuitry 1006a may also include synthesizer circuitry 1204 for synthesizing a frequency 1205 for use by the mixer circuitry 1202 and the mixer circuitry 1214. The mixer circuitry 1202 and/or 1214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 12 illustrates only a simplified version of a radio IC circuitry, and may include, although not shown, embodiments where each of the depicted circuitries may include more than one component. For instance, mixer circuitry 1214 may each include one or more mixers, and filter circuitries 1208 and/or 1212 may each include one or more filters, such as one or more BPFs and/or LPFs according to application needs. For example, when mixer circuitries are of the direct-conversion type, they may each include two or more mixers.

In some embodiments, mixer circuitry 1202 may be configured to down-convert RF signals 1107 received from the FEM circuitry 1004a-b (FIG. 10) based on the synthesized frequency 1205 provided by synthesizer circuitry 1204. The amplifier circuitry 1206 may be configured to amplify the down-converted signals and the filter circuitry 1208 may include an LPF configured to remove unwanted signals from the down-converted signals to generate output baseband signals 1207. Output baseband signals 1207 may be provided to the baseband processing circuitry 1008a-b (FIG. 10) for further processing. In some embodiments, the output baseband signals 1207 may be zero-frequency baseband signals, although this is not a requirement. In some embodiments, mixer circuitry 1202 may comprise passive mixers, although the scope of the embodiments is not limited in this respect.

In some embodiments, the mixer circuitry 1214 may be configured to up-convert input baseband signals 1211 based on the synthesized frequency 1205 provided by the synthesizer circuitry 1204 to generate RF output signals 1109 for the FEM circuitry 1004a-b. The baseband signals 1211 may be provided by the baseband processing circuitry 1008a-b and may be filtered by filter circuitry 1212. The filter circuitry 1212 may include an LPF or a BPF, although the scope of the embodiments is not limited in this respect.

In some embodiments, the mixer circuitry 1202 and the mixer circuitry 1214 may each include two or more mixers and may be arranged for quadrature down-conversion and/or up-conversion respectively with the help of synthesizer 1204. In some embodiments, the mixer circuitry 1202 and the mixer circuitry 1214 may each include two or more mixers each configured for image rejection (e.g., Hartley image rejection). In some embodiments, the mixer circuitry 1202 and the mixer circuitry 1214 may be arranged for direct down-conversion and/or direct up-conversion, respectively. In some embodiments, the mixer circuitry 1202 and the mixer circuitry 1214 may be configured for super-heterodyne operation, although this is not a requirement.

Mixer circuitry 1202 may comprise, according to one embodiment: quadrature passive mixers (e.g., for the in-phase (I) and quadrature phase (Q) paths). In such an embodiment, RF input signal 1107 from FIG. 12 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1205 of synthesizer 1204 (FIG. 12). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1107 (FIG. 11) may comprise a balanced signal, although the scope of the embodiments is not limited in this respect. The I and Q baseband output signals may be provided to low-noise amplifier, such as amplifier circuitry 1206 (FIG. 12) or to filter circuitry 1208 (FIG. 12).

In some embodiments, the output baseband signals 1207 and the input baseband signals 1211 may be analog baseband signals, although the scope of the embodiments is not limited in this respect. In some alternate embodiments, the output baseband signals 1207 and the input baseband signals 1211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1204 may be a fractional-N synthesizer or a fractional N/N+1 synthesizer, although the scope of the embodiments is not limited in this respect as other types of frequency synthesizers may be suitable. For example, synthesizer circuitry 1204 may be a delta-sigma synthesizer, a frequency multiplier, or a synthesizer comprising a phase-locked loop with a frequency divider. According to some embodiments, the synthesizer circuitry 1204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1204 may be provided by a voltage controlled oscillator (VCO), although that is not a requirement. A divider control input may further be provided by either the baseband processing circuitry 1008a-b (FIG. 10) depending on the desired output frequency 1205. In some embodiments, a divider control input (e.g., N) may be determined from a look-up table (e.g., within a Wi-Fi card) based on a channel number and a channel center frequency as determined or indicated by the example application processor 1010. The application processor 1010 may include, or otherwise be connected to, one of the example secure signal converter 101 or the example received signal converter 103 (e.g., depending on which device the example radio architecture is implemented in).

In some embodiments, synthesizer circuitry 1204 may be configured to generate a carrier frequency as the output frequency 1205, while in other embodiments, the output frequency 1205 may be a fraction of the carrier frequency (e.g., one-half the carrier frequency, one-third the carrier frequency). In some embodiments, the output frequency 1205 may be a LO frequency (fLO).

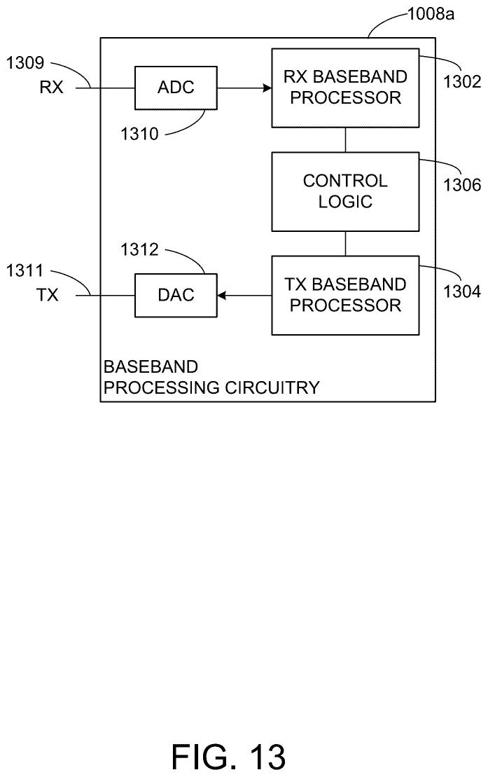

FIG. 13 illustrates a functional block diagram of baseband processing circuitry 1008a in accordance with some embodiments. The baseband processing circuitry 1008a is one example of circuitry that may be suitable for use as the baseband processing circuitry 1008a (FIG. 10), although other circuitry configurations may also be suitable. Alternatively, the example of FIG. 12 may be used to implement the example BT baseband processing circuitry 1008b of FIG. 10.

The baseband processing circuitry 1008a may include a receive baseband processor (RX BBP) 1302 for processing receive baseband signals 1209 provided by the radio IC circuitry 1006a-b (FIG. 10) and a transmit baseband processor (TX BBP) 1304 for generating transmit baseband signals 1211 for the radio IC circuitry 1006a-b. The baseband processing circuitry 1008a may also include control logic 1306 for coordinating the operations of the baseband processing circuitry 1008a.

In some embodiments (e.g., when analog baseband signals are exchanged between the baseband processing circuitry 1008a-b and the radio IC circuitry 1006a-b), the baseband processing circuitry 1008a may include ADC 1310 to convert analog baseband signals 1309 received from the radio IC circuitry 1006a-b to digital baseband signals for processing by the RX BBP 1302. In these embodiments, the baseband processing circuitry 1008a may also include DAC 1312 to convert digital baseband signals from the TX BBP 1304 to analog baseband signals 1311.

In some embodiments that communicate OFDM signals or OFDMA signals, such as through baseband processor 1008a, the transmit baseband processor 1304 may be configured to generate OFDM or OFDMA signals as appropriate for transmission by performing an inverse fast Fourier transform (IFFT). The receive baseband processor 1302 may be configured to process received OFDM signals or OFDMA signals by performing an FFT. In some embodiments, the receive baseband processor 1302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 10, in some embodiments, the antennas 1001 (FIG. 10) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1001 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device of a non-access point multi-link device (non-AP MLD) comprising processing circuitry coupled to storage, the processing circuitry configured to: transmit, to a current AP MLD, a request frame including a media access control (MAC) address of a target AP MLD; and initiate context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple}, wherein each variable in the UP{tuple} represents a user priority associated with a value tuple of a masked classifier parameters, corresponding to the active MSCS from the current AP MLD to the target AP MLD.

Example 2 may include the device of example 1 and/or some other example(s) herein, wherein initiating the context transfer may include triggering a distribution system (DS) mapping change notification to a DS.

Example 3 may include the device of example 1 and/or some other example(s) herein, wherein the request frame may include the MAC address of the current AP MLD may be transmitted to the target AP MLD to initiate the context transfer from the current AP MLD to the target AP MLD.

Example 4 may include the device of example 1 and/or some other example(s) herein, where in the APs affiliated with the current AP MLD and the target AP MLD has the same setting of SCS field, Mirrored SCS field, QoS Map field in Extended capabilities field in Extended Capabilities element.

Example 5 may include the device of example 1 and/or some other example(s) herein, wherein the processing circuitry may be further configured to cause to embed an element in the request frame to setup a new context with the target AP MLD.

Example 6 may include the device of example 2 and/or some other example(s) herein, wherein an additional request or response frame exchange may be done before the request and response exchange that initiates the DS mapping change.

Example 7 may include the device of example 6 and/or some other example(s) herein, wherein the additional request or response frame may include SNonce and DH parameter and the additional response frame may include ANonce and DH parameter to derive new PTK.

Example 8 may include the device of example 6 and/or some other example(s) herein, wherein the additional request and response exchange may be with the current AP MLD and the request frame may include the target AP MLD MAC address or the additional request and response exchange may be with the target AP MLD and the request frame may include a current AP MLD MAC address.

Example 9 may include the device of example 6 and/or some other example(s) herein, wherein the additional request and response exchange also initiates context transfer from the current AP MLD to the target AP MLD may include the contexts defined in claim.

Example 10 may include the device of example 1 and/or some other example(s) herein, wherein each UP tuple may include a plurality of classifier parameters including at least a source IP address, destination IP address, and protocol type.

Example 11 may include a non-transitory computer-readable medium storing computer-executable instructions which when executed by one or more processors of a non-access point multi-link device (non-AP MLD) result in performing operations comprising: transmitting, to a current AP MLD, a request frame including a media access control (MAC) address of a target AP MLD; and initiating context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP) { tuple}, wherein each variable in the UP{tuple} represents a user priority associated with a value tuple of a masked classifier parameters, corresponding to the active MSCS from the current AP MLD to the target AP MLD.

Example 12 may include the non-transitory computer-readable medium of example 11 and/or some other example(s) herein, wherein initiating the context transfer may include triggering a distribution system (DS) mapping change notification to a DS.

Example 13 may include the non-transitory computer-readable medium of example 11 and/or some other example(s) herein, wherein the request frame may include the MAC address of the current AP MLD may be transmitted to the target AP MLD to initiate the context transfer from the current AP MLD to the target AP MLD.

Example 14 may include the non-transitory computer-readable medium of example 11 and/or some other example(s) herein, where in the APs affiliated with the current AP MLD and the target AP MLD has the same setting of SCS field, Mirrored SCS field, QoS Map field in Extended capabilities field in Extended Capabilities element.

Example 15 may include the non-transitory computer-readable medium of example 11 and/or some other example(s) herein, wherein the operations further comprise causing to embed an element in the request frame to setup a new context with the target AP MLD.

Example 16 may include the non-transitory computer-readable medium of example 12 and/or some other example(s) herein, wherein an additional request or response frame exchange may be done before the request and response exchange that initiates the DS mapping change.

Example 17 may include the non-transitory computer-readable medium of example 16 and/or some other example(s) herein, wherein the additional request or response frame may include SNonce and DH parameter and the additional response frame may include ANonce and DH parameter to derive new PTK.

Example 18 may include the non-transitory computer-readable medium of example 16 and/or some other example(s) herein, wherein the additional request and response exchange may be with the current AP MLD and the request frame may include the target AP MLD MAC address or the additional request and response exchange may be with the target AP MLD and the request frame may include a current AP MLD MAC address.

Example 19 may include the non-transitory computer-readable medium of example 16 and/or some other example(s) herein, wherein the additional request and response exchange also initiates context transfer from the current AP MLD to the target AP MLD may include the contexts defined in claim.

Example 20 may include the non-transitory computer-readable medium of example 11 and/or some other example(s) herein, wherein each UP tuple may include a plurality of classifier parameters including at least a source IP address, destination IP address, and protocol type.

Example 21 may include a method comprising: transmitting, by one or more processors of a non-access point multi-link device (non-AP MLD) to a current AP MLD, a request frame including a media access control (MAC) address of a target AP MLD; and initiating context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple}, wherein each variable in the UP{tuple} represents a user priority associated with a value tuple of a masked classifier parameters, corresponding to the active MSCS from the current AP MLD to the target AP MLD.

Example 22 may include the method of example 21 and/or some other example(s) herein, wherein initiating the context transfer may include triggering a distribution system (DS) mapping change notification to a DS.

Example 23 may include the method of example 21 and/or some other example(s) herein, wherein the request frame may include the MAC address of the current AP MLD may be transmitted to the target AP MLD to initiate the context transfer from the current AP MLD to the target AP MLD.

Example 24 may include the method of example 21 and/or some other example(s) herein, where in the APs affiliated with the current AP MLD and the target AP MLD has the same setting of SCS field, Mirrored SCS field, QoS Map field in Extended capabilities field in Extended Capabilities element.

Example 25 may include the method of example 21 and/or some other example(s) herein, further comprising causing to embed an element in the request frame to setup a new context with the target AP MLD.

Example 26 may include the method of example 22 and/or some other example(s) herein, wherein an additional request or response frame exchange may be done before the request and response exchange that initiates the DS mapping change.

Example 27 may include the method of example 26 and/or some other example(s) herein, wherein the additional request or response frame may include SNonce and DH parameter and the additional response frame may include ANonce and DH parameter to derive new PTK.

Example 28 may include the method of example 26 and/or some other example(s) herein, wherein the additional request and response exchange may be with the current AP MLD and the request frame may include the target AP MLD MAC address or the additional request and response exchange may be with the target AP MLD and the request frame may include a current AP MLD MAC address.

Example 29 may include the method of example 26 and/or some other example(s) herein, wherein the additional request and response exchange also initiates context transfer from the current AP MLD to the target AP MLD may include the contexts defined in claim.

Example 30 may include the method of example 21 and/or some other example(s) herein, wherein each UP tuple may include a plurality of classifier parameters including at least a source IP address, destination IP address, and protocol type.

Example 31 may include an apparatus comprising means for: transmitting, to a current AP MLD, a request frame including a media access control (MAC) address of a target AP MLD; and initiating context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple}, wherein each variable in the UP{tuple} represents a user priority associated with a value tuple of a masked classifier parameters, corresponding to the active MSCS from the current AP MLD to the target AP MLD.

Example 32 may include the apparatus of example 31 and/or some other example(s) herein, wherein initiating the context transfer may include triggering a distribution system (DS) mapping change notification to a DS.

Example 33 may include the apparatus of example 31 and/or some other example(s) herein, wherein the request frame may include the MAC address of the current AP MLD may be transmitted to the target AP MLD to initiate the context transfer from the current AP MLD to the target AP MLD.

Example 34 may include the apparatus of example 31 and/or some other example(s) herein, where in the APs affiliated with the current AP MLD and the target AP MLD has the same setting of SCS field, Mirrored SCS field, QoS Map field in Extended capabilities field in Extended Capabilities element.

Example 35 may include the apparatus of example 31 and/or some other example(s) herein, further comprising causing to embed an element in the request frame to setup a new context with the target AP MLD.

Example 36 may include the apparatus of example 32 and/or some other example(s) herein, wherein an additional request or response frame exchange may be done before the request and response exchange that initiates the DS mapping change.

Example 37 may include the apparatus of example 36 and/or some other example(s) herein, wherein the additional request or response frame may include SNonce and DH parameter and the additional response frame may include ANonce and DH parameter to derive new PTK.

Example 38 may include the apparatus of example 36 and/or some other example(s) herein, wherein the additional request and response exchange may be with the current AP MLD and the request frame may include the target AP MLD MAC address or the additional request and response exchange may be with the target AP MLD and the request frame may include a current AP MLD MAC address.

Example 39 may include the apparatus of example 36 and/or some other example(s) herein, wherein the additional request and response exchange also initiates context transfer from the current AP MLD to the target AP MLD may include the contexts defined in claim.

Example 40 may include the apparatus of example 31 and/or some other example(s) herein, wherein each UP tuple may include a plurality of classifier parameters including at least a source IP address, destination IP address, and protocol type.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device of a non-access point multi-link device (non-AP MLD), the device comprising processing circuitry coupled to storage, the processing circuitry configured to:
transmit, to a current AP MLD, a request frame including a media access control (MAC) address of a target AP MLD; and
initiate context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple},
wherein each variable in the UP{tuple} represents a user priority associated with a value tuple of a masked classifier parameters, corresponding to the active MSCS from the current AP MLD to the target AP MLD.

2. The device of claim 1, wherein initiating the context transfer includes triggering a distribution system (DS) mapping change notification to a DS.

3. The device of claim 1, wherein the request frame includes the MAC address of the current AP MLD is transmitted to the target AP MLD to initiate the context transfer from the current AP MLD to the target AP MLD.

4. The device of claim 1, where in the APs affiliated with the current AP MLD and the target AP MLD has the same setting of SCS field, Mirrored SCS field, QoS Map field in Extended capabilities field in Extended Capabilities element.

5. The device of claim 1, wherein the processing circuitry is further configured to cause to embed an element in the request frame to setup a new context with the target AP MLD.

6. The device of claim 2, wherein an additional request or response frame exchange is done before the request and response exchange that initiates the DS mapping change.

7. The device of claim 6, wherein the additional request or response frame includes SNonce and DH parameter and the additional response frame includes ANonce and DH parameter to derive new PTK.

8. The device of claim 6, wherein the additional request and response exchange is with the current AP MLD and the request frame includes the target AP MLD MAC address or the additional request and response exchange is with the target AP MLD and the request frame includes a current AP MLD MAC address.

9. The device of claim 6, wherein the additional request and response exchange also initiates context transfer from the current AP MLD to the target AP MLD includes the contexts defined in claim.

10. The device of claim 1, wherein each UP tuple includes a plurality of classifier parameters including at least a source IP address, destination IP address, and protocol type.

11. A non-transitory computer-readable medium storing computer-executable instructions which when executed by one or more processors a non-access point multi-link device (non-AP MLD) result in performing operations comprising:
transmitting, to a current AP MLD, a request frame including a media access control (MAC) address of a target AP MLD; and
initiating context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple},
wherein each variable in the UP{tuple} represents a user priority associated with a value tuple of a masked classifier parameters, corresponding to the active MSCS from the current AP MLD to the target AP MLD.

12. The non-transitory computer-readable medium of claim 11, wherein initiating the context transfer includes triggering a distribution system (DS) mapping change notification to a DS.

13. The non-transitory computer-readable medium of claim 11, wherein the request frame includes the MAC address of the current AP MLD is transmitted to the target AP MLD to initiate the context transfer from the current AP MLD to the target AP MLD.

14. The non-transitory computer-readable medium of claim 11, where in the APs affiliated with the current AP MLD and the target AP MLD has the same setting of SCS field, Mirrored SCS field, QoS Map field in Extended capabilities field in Extended Capabilities element.

15. The non-transitory computer-readable medium of claim 11, wherein the operations further comprise causing to embed an element in the request frame to setup a new context with the target AP MLD.

16. The non-transitory computer-readable medium of claim 12, wherein an additional request or response frame exchange is done before the request and response exchange that initiates the DS mapping change.

17. The non-transitory computer-readable medium of claim 16, wherein the additional request or response frame includes SNonce and DH parameter and the additional response frame includes ANonce and DH parameter to derive new PTK.

18. The non-transitory computer-readable medium of claim 16, wherein the additional request and response exchange is with the current AP MLD and the request frame includes the target AP MLD MAC address or the additional request and response exchange is with the target AP MLD and the request frame includes a current AP MLD MAC address.

19. The non-transitory computer-readable medium of claim 16, wherein the additional request and response exchange also initiates context transfer from the current AP MLD to the target AP MLD includes the contexts defined in claim.

20. A method comprising:
transmitting, by one or more processors of a non-access point multi-link device (non-AP MLD), to a current AP MLD, a request frame including a media access control (MAC) address of a target AP MLD; and
initiating context transfer of a stream classification service (SCS) descriptor element from the non-AP MLD corresponding to a negotiated SCS stream, a mirrored stream classification service (MSCS) descriptor element from the non-AP MLD corresponding to an active MSCS, and a logical list of user priority (UP){tuple},
wherein each variable in the UP{tuple} represents a user priority associated with a value tuple of a masked classifier parameters, corresponding to the active MSCS from the current AP MLD to the target AP MLD.
